(19) United States
(12) Patent Application Publication
(10) Pub. No.: US 2017/0203471 A1
(43) Pub. Date: Jul. 20, 2017

(54) IMPRINT TEMPLATE AND METHOD FOR PRODUCING THE SAME

(71) Applicants: TOYAMA PREFECTURE, Toyama-shi (JP); KYORITSU CHEMICAL & CO., LTD., Tokyo (JP); ZEON CORPORATION, Tokyo (JP)

(72) Inventors: Tsutomu OBATA, Toyama (JP); Yoshiyuki YOKOYAMA, Toyama (JP); Masaaki NASUNO, Toyama (JP); Mikiharu KUCHIKI, Tokyo (JP); Tomoshi AONO, Chiba (JP); Motofumi KASHIWAGI, Tokyo (JP)

(21) Appl. No.: 15/476,446

(22) Filed: Mar. 31, 2017

Related U.S. Application Data
(63) Continuation of application No. PCT/JP2015/070392, filed on Jul. 16, 2015.

(30) Foreign Application Priority Data
Oct. 4, 2014 (JP) 2014-205307

(51) Int. Cl. B29C 33/42; B29C 59/00; B29C 33/38

(52) U.S. Cl. CPC B29C 33/424; B29C 33/3842; B29C 59/002; B29C 2033/426; B29K 2995/0026; B29K 2845/00

(57) ABSTRACT

An imprint template is used for photocuring imprinting, and includes a support plate that is transparent with respect to an exposure wavelength used for photocuring imprinting, and has flexibility; a buffer resin layer that is formed on the support plate, and is formed of an elastic material that is transparent with respect to the exposure wavelength; and a resin film mold that is removably bonded to the buffer resin layer, and is transparent with respect to the exposure wavelength, wherein a concave-convex transfer pattern is formed on a surface of the resin film mold.

### CROSS REFERENCE TO RELATED APPLICATION

This application is a continuation of International Patent Application No. PCT/JP2015/070392, having an international filing date of Jul. 16, 2015, which designated the United States, the entirety of which is incorporated herein by reference. Japanese Patent Application No. 2014-205307 filed on Oct. 4, 2014 is also incorporated herein by reference in its entirety.

### BACKGROUND

The present invention relates to an imprint template and a method for producing the same. In particular, the invention relates to a photocurable nanoimprint template that is suitable for imprinting a nanometer-sized concave-convex pattern (uneven pattern) using UV light or the like, and a method for producing the same.

A semiconductor process that is used to produce a central processing unit (CPU), a memory, and the like that are used for a personal computer and the like has been increasingly refined according to Moore's law.

An increase in brightness (luminance) has been desired for a light-emitting diode (LED) that has attracted attention from the viewpoint of energy-saving and can reduce power consumption, and production technology that can deal with such a demand has been increasingly desired.

A semiconductor process has already achieved nanometer-level refinement, and it is impossible to deal with such refinement using photolithography.

A patterning process that utilizes an electron beam or the like has a problem in terms of throughput, and it is difficult to reduce the refinement cost without solving these problems.

The light extraction efficiency of an LED can be improved by utilizing a patterned sapphire substrate (PSS).

Specifically, it is possible to suppress reflection that occurs at the interface between a nitride semiconductor having a high refractive index and air, and improve the light extraction efficiency and the crystallinity of the nitride semiconductor by forming convexities and concavities having a size of several micrometers on the surface of a sapphire substrate that is used as the substrate of an LED.

In recent years, an LED has been used for an interior lighting application and the like, and has been required to implement color rendition in addition to high brightness.

In particular, warm white illumination tends to be preferred in Europe and America as compared with white illumination, and a method that efficiently implements warm white illumination using an LED has been desired.

For example, a phosphor that emits light due to UV light can be used for a UV LED that emits light having a wavelength shorter than that of a white LED, and three primary light colors having high purity can be obtained by combining them.

It may be possible to implement illumination that can be controlled with respect to color rendition by utilizing a high-brightness UV-LED.

A nanoPSS (nPSS) on which a nanometer-sized pattern is formed has been desired to implement a high-brightness UV-LED.

The nPSS technology has advantages in that it is possible to further improve the light extraction efficiency and crystallinity, and reduce etching time, for example.

Nanoimprint lithographic technology (i.e., printable forming technology) has been proposed as a method for implementing such a nano structure.

In S. Y. Chou et al., Appl. Phys. Lett., vol. 67 (1995), pp. 3114 (Non-Patent Literature 1), for example, a fine structure is transferred by applying hot-pressing technology.

According to this method, since a fine pattern drawing process that has a problem with respect to throughput is used for only embossing, and a pattern is formed by deforming and forcing a resist into a mold, the mold accuracy is reflected in the pattern accuracy.

“Nanoimprint—Sentanbisaikakou no Saizensen”, Toray Research Center Inc., pp. 29-34 (Non-Patent Literature 2) discloses photonanoimprint technology that applies pressure to a resist applied to a substrate using a mold, and applies UV light to the resist with which the mold is filled to cure the resin and transfer the pattern.

Since the photonanoimprint technology can be implemented at room temperature, the photonanoimprint technology has advantage over thermal nanoimprint technology in that heating is unnecessary, a dimensional change due to thermal expansion occurs to only a small extent, and the device can be simplified.

Examples of a typical transfer method that utilizes an imprint device (e.g., thermal nanoimprint device and photonanoimprint device) include a batch-type transfer method that transfers a pattern onto a substrate at a time, and a step & repeat transfer method that repeats imprinting using a mold having a small area.

The batch-type transfer method achieves high throughput since the substrate and the mold are pressed at one time to transfer the pattern.

However, it is necessary to ensure a uniform in-plane press pressure, and deal with an increase in release force due to an increase in area.

The step & repeat transfer method has problems with respect to the stitching accuracy, a variation in pattern shot, and the like.

A sapphire substrate used for an LED warps as the diameter increases, for example.

In particular, when a nano-scale pattern is formed on the surface of the substrate, it is necessary to use at least an exposure device such as a stepper. In this case, a defocus state and a decrease in stitching accuracy occur if the substrate is curved (warped).

Therefore, technology (e.g., nanoimprint technology) that brings a mold on which fine convexities and concavities are formed into direct contact with a substrate to transfer the pattern, is desired.

The nanoimprint technology requires a master mold for transferring a concave-convex pattern.

A master mold is normally very expensive, and hinders the widespread use of the nanoimprint technology.

A method that uses a replica template instead of an expensive master mold has been proposed.

For example, JP-A-2007-55235 discloses transferring the pattern of a master mold onto a cyclo-olefin copolymer film, and implementing imprinting using the cyclo-olefin copolymer film as a replica.

According to this method, it is possible to implement imprinting at low cost by utilizing a replica as the mold that is most expensive.

Since the substrate is sucked under vacuum, and it is necessary to apply pressure from the back side of the replica mold, it is possible to prevent a situation in which air enters the space between the substrate and the mold during imprinting, although a complex device is required.

However, since the mold is removed at one time, the mold may be contaminated, and one mold may be required for each imprinting step, whereby a reduction in cost is limited.

Ran Ji et.al., “UV Enhanced Substrate Conformal Imprint Lithography (UV-SCIL) Technique for Photonic Crystals Patterning in LED Manufacturing”, http://www.suss.com/en/media/technical-publications/(Non-Patent Literature 3) discloses implementing imprinting using a replica template that is produced by transferring the concave-convex pattern of a master mold onto the surface of a PDMS resin that provided on a glass support substrate.

Since air pressure is applied stepwise from the back side of the replica template by utilizing the rigidity of glass, it is possible to prevent a situation in which air enters the space between the substrate and the mold, and obtain good followability with respect to warping of the substrate, for example.

Since the PDMS resin is removed from the substrate as if to slowly peel a tape, it is possible to suppress a situation in which in which the resist formed on the substrate is damaged, and only a small release force is required even when printing is performed over a large area.

However, when the resist has adhered to the replica template due to insufficient exposure or the like, it is difficult to perform cleaning using a solvent or the like (i.e., a considerable increase in cost occurs due to defects).

It is difficult to use a radically curable resist when it is desired to effect complete photocuring so that adhesion or the like does not occur.

Moreover, a dimensional change may occur when the imprinting step is repeated.

Since the replica template is produced from the master mold using a PDMS resin that has a low curing speed, the throughput during production decreases. Moreover, since the master mold may be damaged (i.e., it may be difficult to use an expensive master mold again) when removing the replica from the master mold, skill is required for the operation, and it is difficult to implement automated and labor-saving production.

JP-A-2009-119695 discloses a replica template in which an intermediate layer is formed on a support substrate using a light-transmitting material, and a resin pattern layer is formed on the intermediate layer.

A concave-convex pattern is formed on the resin pattern layer, and the intermediate layer having elasticity is provided to facilitate pattern transfer during imprinting.

The resin pattern layer is formed by applying a resin to a small thickness.

However, the support substrate is required to have a thickness of about 0.5 to 10 mm, and exhibit mechanical strength.

It is possible to obtain followability even when there is a pattern protrusion or foreign matter. However, it is impossible to deal with warping of the substrate, for example, since the support member is rigid.

Since the replica template is not flexible, it is likely that air enters the space between the mold and the substrate when the pressure is not reduced, when the substrate has a large area.

Moreover, a large release force is required when the substrate has a large area. Moreover, it is difficult to implement regeneration by cleaning or the like in the same manner as described above in connection with Non-Patent Literature 3.

JP-A-2004-299153 utilizes an elastic material as a buffer layer (intermediate layer). However, it is difficult to accurately form members that differ in modulus of elasticity, as disclosed in JP-A-2004-299153.

JP-A-2010-49745 discloses a structure that includes a base, an intermediate layer that is formed of an elastic body, and a pattern-forming layer having a concave-convex pattern. However, since a resin material is applied by spin coating with respect to the pattern-forming layer, a transfer defect may occur due to a liquid puddle at the edge, or sufficient cleaning may be difficult when the surface has been contaminated.

JP-A-2013-110135 discloses a configuration that includes a photocurable resin sheet on which a concave-convex pattern is formed, a polymer film that provides a self-support capability, and a primer layer that bonds the photocurable resin sheet and the polymer film.

In JP-A-2013-110135, the primer layer is used to bond the photocurable resin sheet and the polymer film, and may be omitted as long as the polymer film exhibits adhesion.

The polymer film that is used as a support must have a flexibility sufficient to deal with a roll-to-roll process.

According to the technology disclosed in JP-A-2013-110135, it is easy to produce a long product, but flexure, wrinkles, a shift, and the like may occur particularly when implementing large-area transfer.

Japanese Patent No. 5315513 discloses production of a high-brightness semiconductor deep UV LED.

The UV LED disclosed in Japanese Patent No. 5315513 is produced by forming a fine structure on the substrate using a nanoimprint method in order to improve the external quantum efficiency.

In particular, sapphire and the like tend to warp, and the film mold must follow such warping.

In Japanese Patent No. 5315513, a UV-curable resin is applied to a film. After pressing a master mold against the UV-curable resin, the UV-curable resin is cured to form a concave-convex pattern (formed by the UV-curable resin) on the surface of the film.

However, flexure and wrinkles easily occur when it is desired to implement an increase in area.

Japanese Patent No. 5117318 discloses a stamper that integrally includes a flexible hard stamper base, a stamper buffer layer, and a stamp pattern layer.

In Japanese Patent No. 5117318, a photocurable resin is applied directly to a master mold using a dispensing method, a spin coating method, or the like, brought into contact with the stamper buffer layer, and photocured.

However, the hard stamper base disclosed in Japanese Patent No. 5117318 must have a thickness of about 0.7 mm, and exhibit strength.

According to the technology disclosed in Japanese Patent No. 5117318, it is likely that the photocurable resin may not be cured, or may not be sufficiently removed from the master mold, or may not sufficiently adhere to the stamper buffer layer. In such a case, a considerable increase in cost occurs.

### SUMMARY

An object of the invention is to provide an imprint template that is used to implement photocuring imprinting, suppresses the entry of air, exhibits an excellent transfer capability with respect to even a curved substrate, and is inexpensive, and a method for producing the same.

More specifically, an object of the invention is to provide a flexible replica template that exhibits excellent followability with respect to a substrate when used to implement photonanoimprinting, and does not require a large release force, and a method for producing the same.

Another object of the invention is to provide a method that can easily clean or replace a concave-convex pattern that is easily damaged.

A further object of the invention is to implement large-area transfer by providing a template that is rigid, but easily warps with high controllability upon application of pressure.

The inventors found an imprint template that flexibly follows a substrate, prevents the entry of air even when the substrate has a large area, and implements a reduction in release force and cost, and a method for producing the same. This finding has led to the completion of the invention.

According to one aspect of the invention, there is provided an imprint template comprising:

a support plate that is transparent with respect to an exposure wavelength used for photocuring imprinting, and has flexibility;

a buffer resin layer that is formed on the support plate, and is transparent with respect to the exposure wavelength; and

a resin film mold that is removably bonded to the buffer resin layer, and is transparent with respect to the exposure wavelength,

wherein a concave-convex transfer pattern is formed on a surface of the resin film mold.

The concave-convex transfer pattern that is formed on the resin film mold may be formed by a combination of one or more concave-convex transfer patterns. Specifically, the concave-convex transfer pattern that is formed on the resin film mold may be formed by transferring the pattern of a master mold using a batch-type transfer method, or may be formed by transferring the pattern of a master mold using a step & repeat transfer method, or may be formed by transferring the patterns of a plurality of master molds. Alternatively, a plurality of resin film molds may be bonded to the buffer resin layer.

The invention is characterized in that the support plate has flexibility. It is preferable that the support plate be formed of transparent glass or a transparent resin, and have a thickness of 0.1 mm or more and less than 0.5 mm.

FIG. 7 illustrates the graph disclosed in Katsutoshi Fujiwara, NEW GLASS, Vol. 24, No. 2 (2009), pp. 90-93 (Non-Patent Literature 4).

As illustrated in FIG. 7, the radius of curvature decreases (i.e., the glass has better flexibility) as the thickness of the glass decreases.

However, the glass easily breaks, or the handling capability deteriorates when the thickness of the glass is too small. Therefore, the thickness of the glass must be 0.1 mm or more.

Since the flexibility of the glass decreases as the thickness of the glass increases, it is preferable that the thickness of the glass be less than 0.5 mm.

The support plate may be formed of a transparent resin as long as the resin is transparent with respect to the exposure wavelength required for photocuring during imprinting, and has flexibility.

For example, the support plate may be formed of a cyclo-olefin resin (cyclo-olefin polymer resin), a PC resin, a PET resin, an acrylic resin, or the like. Specific examples of the transparent resin include ZEONOR (manufactured by Zeon Corporation), ARTON (manufactured by JSR Corporation), and the like.

The buffer resin layer is formed of a material that is transparent with respect to the exposure wavelength required for photocuring during imprinting, and has elasticity. The buffer resin layer may be formed using a dimethylpolysiloxane (PDMS) resin, an acrylic-based polymer pressure-sensitive adhesive resin, or the like, for example.

According to the invention, since the resin film mold is bonded to the buffer resin layer that is provided on the flexible support plate and has elasticity, it is possible to provide a replica template that is flexible, and has good controllability with respect to the pressurization conditions.

The invention is characterized in that the resin film mold can be bonded and removed, and can be appropriately cleaned.

Examples of a material for forming the resin film mold include a cyclo-olefin resin (cyclo-olefin polymer resin) (e.g., ZEONOR (manufactured by Zeon Corporation)), and a polyethylene terephthalate (PET) film.

In the imprint template, a release film may be formed on the surface of the resin film mold at least in an area in which the concave-convex transfer pattern is formed.

According to another aspect of the invention, there is provided a method for producing an imprint template comprising:

forming a buffer resin layer on a surface of a support plate, the support plate being transparent with respect to an exposure wavelength used for photocuring imprinting, and having flexibility, and the buffer resin layer being formed of an elastic material that is transparent with respect to the exposure wavelength; and

subjecting a back surface of a resin film mold that is transparent with respect to the exposure wavelength to a plasma treatment, and bonding the back surface of the resin film mold to a surface of the buffer resin layer, a concave-convex transfer pattern being formed on a front surface of the resin film mold.

Examples of the buffer resin used in connection with the invention include a dimethylpolysiloxane (PDMS) resin and an acrylic-based polymer pressure-sensitive adhesive resin.

The PDMS resin is commercially available as Sylgard 184 (manufactured by Dow Corning Corporation), X-34-4184-A/B manufactured by Shin-Etsu Silicone Co., Ltd., and the like.

The acrylic-based polymer pressure-sensitive adhesive resin is commercially available as a World Rock HRJ series (optical elastic resin) (manufactured by Kyoritsu

Chemical & Co., Ltd.).

According to the invention, it is possible to obtain an imprint template that can form a nano-scale and sub-micrometer-scale concave-convex pattern on a substrate that differs in diameter (small diameter to large diameter) and may be curved (warped).

It is also possible to obtain an excellent transfer-release capability, and easily clean and replace the mold.

### BRIEF DESCRIPTION OF THE DRAWINGS

FIG. 1 illustrates an example of the structure of the imprint template according to the invention.

FIG. 2 illustrates an example of a method for producing an imprint template.

FIG. 3 illustrates an example of a transfer method that utilizes the imprint template according to the invention.

FIG. 4 illustrates a photograph of the outward appearance of the nanoimprint template according to the invention.

FIG. 5 is a birds-eye view obtained by observing a transfer pattern using a scanning probe microscope.

FIG. 6 is a schematic view illustrating an example in which a design is formed by combining a plurality of resin film molds.

FIG. 7 illustrates the relationship between the radius of curvature and the tensile stress with respect to the thickness of glass.

### DESCRIPTION OF EXEMPLARY EMBODIMENTS

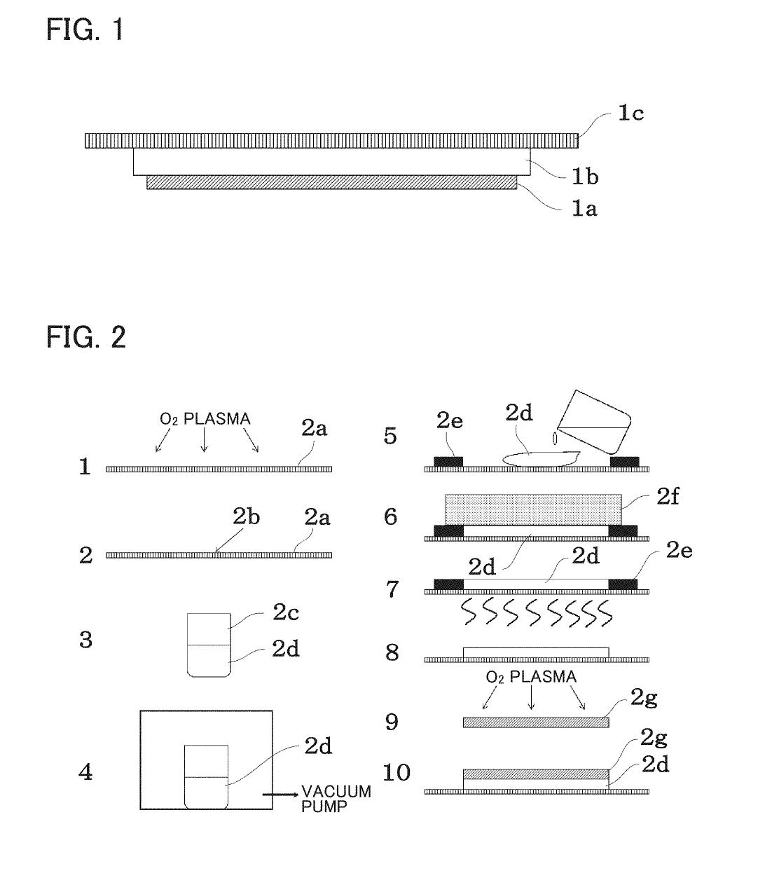

FIG. 1 illustrates the structure of a replica template (imprint template) according to the invention.

The replica template includes a resin mold film 1a on which a concave-convex pattern is formed, and a support plate 1c that supports the resin mold film 1a. A transparent buffer resin layer 1b that exhibits flexibility and elasticity is provided between the resin mold film 1a and the support plate 1c.

The resin mold film 1a is formed using a cyclo-olefin polymer resin (e.g., ZEONOR manufactured by Zeon Corporation) that exhibits excellent transparency with respect to an exposure wavelength used for photocuring imprinting, heat resistance, and the like, for example.

The film 1a is required to exhibit flexibility, and has a thickness of 20 μm to 0.5 mm, and preferably 20 μm to 0.2 mm.

A ZEONOR series manufactured by Zeon Corporation includes films having a thickness of 40 μm to 0.18 mm.

For example, ZEONOR 1060R has a thickness of 0.1 mm, and has the following properties.

Specifically, ZEONOR 1060R has a specific gravity of 1.01 g/cm³, a total light transmittance of 92% (thickness: 3 mm), a coefficient of linear expansion of 7×10⁻⁵/° C., a deflection temperature under load of 99° C., a tensile strength of 53 MPa, and a flexural strength of 76 MPa. Note that the total light transmittance is measured by use of parallel and diffuse rays as incident rays, and is defined in JIS K 7375: 2008.

ZEONOR 1060R exhibits excellent chemical resistance, and is not eroded by acetone, methanol, isopropyl alcohol, and 10% sulfuric acid.

A PET film having the following properties may also be used as the film la. Specifically, a PET film having a specific gravity of 1.4 g/cm³, a total light transmittance of 89%, a coefficient of linear expansion of 1.5×10⁻⁵/° C., a deflection temperature under load of 70 to 104° C., a tensile strength of 48 to 73 MPa, and a flexural strength of 96 to 131 MPa, may be used as the film la.

Such a PET film exhibits excellent chemical resistance with respect to ethanol, isopropyl alcohol, 10% sulfuric acid, and the like.

The transparent buffer resin layer 1b is an elastic body that is transparent with respect to the photocuring exposure wavelength that is employed during imprint. For example, the transparent buffer resin layer 1b may be formed using a dimethylpolysiloxane (PDMS) resin, an acrylic-based polymer pressure-sensitive adhesive resin, or the like. The transparent buffer resin layer 1b is required to exhibit a buffer capability, and has a thickness of 0.1 to 10 mm, and preferably 0.1 to 0.6 mm.

For example, a PDMS resin “Sylgard 184” (manufactured by Dow Corning Corporation) has the following properties.

Specifically, Sylgard 184 has a specific gravity of 1.04 g/cm³, a hardness (JIS Type A) of 44, and a transmittance (380 nm) of 89.8%.

An acrylic-based polymer pressure-sensitive adhesive resin “HRJ-40” (manufactured by Kyoritsu Chemical & Co., Ltd.) has the following properties.

Specifically, HRJ-40 has a specific gravity of 0.92 g/cm³, a hardness (JIS Type A) of 17, a modulus of elasticity of 0.6 MPa, and a transmittance (380 nm) of 90% or more.

The support plate 1c is preferably formed of glass. For example, quartz glass that is transparent with respect to light having a wavelength of 360 nm or more (e.g., D 263 Teco manufactured by Schott) may be used.

The support plate 1c is required to exhibit flexibility, and has a thickness of 0.1 mm or more and less than 0.5 mm, and preferably 0.1 to 0.25 mm.

D 263 Teco has the following properties. Specifically, D 263 Teco has a specific gravity of 2.51 g/cm³, a Young's modulus of 72.9 GPa, and a transmittance (380 nm) of 89.8%.

Quartz glass has a specific gravity of 2.2 g/cm³, a Young's modulus of 72 GPa, and a transmittance of 90% or more.

A resin film mold is normally produced by thermal nanoimprint technology that presses a resin film against a master mold that is produced using silicon or Ni electroforming to transfer the concave-convex pattern onto the resin film.

Since the thermal nanoimprint technology has an advantage in that the master mold is damaged to only a small extent, and a plurality of resin film molds can be mass-produced using the master mold, it is possible to provide an imprint mold at low cost.

### Example of Production Method

FIG. 2 illustrates a method for producing the replica template according to the invention.

The steps illustrated in FIG. 2 are described below.
1. A support plate 2a (e.g., quartz glass) is cleaned by an oxygen plasma treatment.
2. A PDMS resin primer 2b is applied to the support plate 2a.
3. A SYLGARD (registered trademark) 184 SILICONE ELASTOMER KIT (PDMS resin 2d) is mixed in a beaker 2c in a weight ratio of 10:1.
4. Air is removed from the PDMS resin 2d by means of vacuum deaeration.
5. A weir (barrier) is formed in a peripheral area of the support plate using a rubber plate 2e having a height of 0.5 mm, for example, and the PDMS resin 2d is poured into the area surrounded by the weir.
6. A squeegee 2f is placed on the rubber weir to spread and smooth the PDMS resin 2d.
7. After the PDMS resin 2d has been smoothed to have the same height as that of the rubber weir 2e, the PDMS resin 2d is cured on a hot plate at 50° C. for 12 hours or more.
8. After confirming that the PDMS resin has been cured, the rubber weir is removed.
9. The back surface of a resin film mold 2g that is situated opposite to the main surface on which a concave-convex pattern is formed, is modified by a plasma treatment (e.g., oxygen plasma treatment).

The plasma treatment ensures that the back surface of the resin film mold 2g and the PDMS resin 2d exhibit adhesion sufficient to endure the imprinting step.
10. The back surface of the resin film mold 2g is placed on the PDMS resin 2d, and the resin film mold 2g is carefully bonded to the PDMS resin 2d that is provided on the support plate.

A hydrophobic release film may be formed on the surface of the resin film mold 2g in order to improve releasability when a pattern is transferred to a resist.

The hydrophobic release film is a monomolecular fluororesin film, for example. The hydrophobic release film may be formed of heptadecafluoro-1,1,2,2-tetrahydrodecyltrichloro silane (FDTS) or tridecafluoro-1,1,2,2-tetrahydrooctyltrichlorosilane (FOTS), for example.

The hydrophobic release film can be easily formed by a vapor deposition process or the like.

The invention is characterized in that the elastic intermediate layer 1b is formed on the support plate 1c that is a flexible support member, and the resin film 1a on which a pattern is formed is bonded to the intermediate layer 1b to provide a replica template that is flexible, has good controllability with respect to the pressurization conditions, and can be easily changed with respect to the transfer pattern.

According to the invention, since the replica template is flexible, the replica template can be caused to adhere to the substrate while preventing a situation in which air enters the space between the replica template and the substrate, and it is possible to select a release method that reduces the release force.

For example, it is possible to gradually bring the template into contact with the substrate from the edge of the substrate while controlling the speed and the pressure, and gradually remove the template from the substrate after exposure from the edge of the substrate while controlling the speed and the like.

It is also possible to allow the flexible replica template to follow the surface of the substrate even when the substrate is curved (warped).

This makes it possible to reduce the pressure to be applied, and reduce the amount of damage applied to the substrate and the pattern.

Since the replica template according to the invention is flexible, but exhibits uniform in-plane rigidity, the replica template is not affected by a variation in stress due to a variation in the size and the density of the concave-convex pattern that is formed on the main surface of the resin film mold.

Even when the surface of the resin film on which the pattern is formed has been contaminated by the resist or the like, it is possible to clean the surface of the resin film using a cleaning agent such as an organic solvent. Therefore, it suffices to replace only the resin film when the lifetime of the pattern layer has been reached.

It is possible to easily form the resin pattern layer as compared with the case of forming a coating-type resin pattern layer, reduce the replacement time, prevent a defect when forming the resin pattern layer, and obtain a stable mold pattern having a small lot-to-lot variation in shape.

Since the pattern is formed by the resin film mold that can be easily removed and bonded, it is possible to automate the film removal-bonding step and the cleaning step.

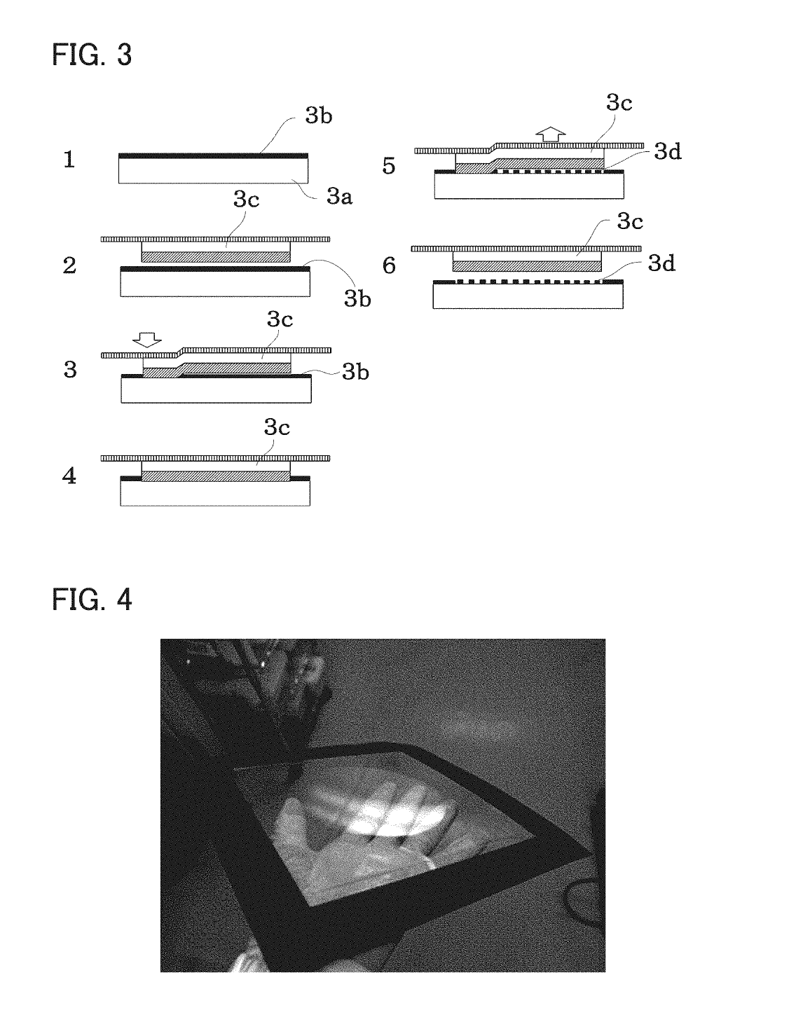

FIG. 3 illustrates a method for forming a nanopillar structure that utilizes a nanoimprint template that is produced according to the invention.
1. A nanoimprint resist 3b (“XIP-3K6P” manufactured by Kyoritsu Chemical & Co., Ltd.) is applied to a sapphire substrate 3a to a thickness of 100 to 200 nm using a spin coating method.
2. A replica template 3c produced according to the invention is placed at a distance of about 100 μm from the surface of the nanoimprint resist 3b so as not to come in contact with the surface of the nanoimprint resist 3b.
3. The concave-convex pattern (back side) of the replica template 3c is slowly pressed against the resist 3b (from the left side in FIG. 3) by applying air pressure.
4. When the entire template has been pressed against the resist 3b, the resin is cured by applying broadband light from a high-pressure mercury lamp.
5. The replica template 3c is slowly removed (from the right side in FIG. 3) from the resist 3d onto which the pattern has been transferred.
6. The concave-convex pattern of the replica template is thus transferred onto the surface of the substrate by means of the resist 3d.

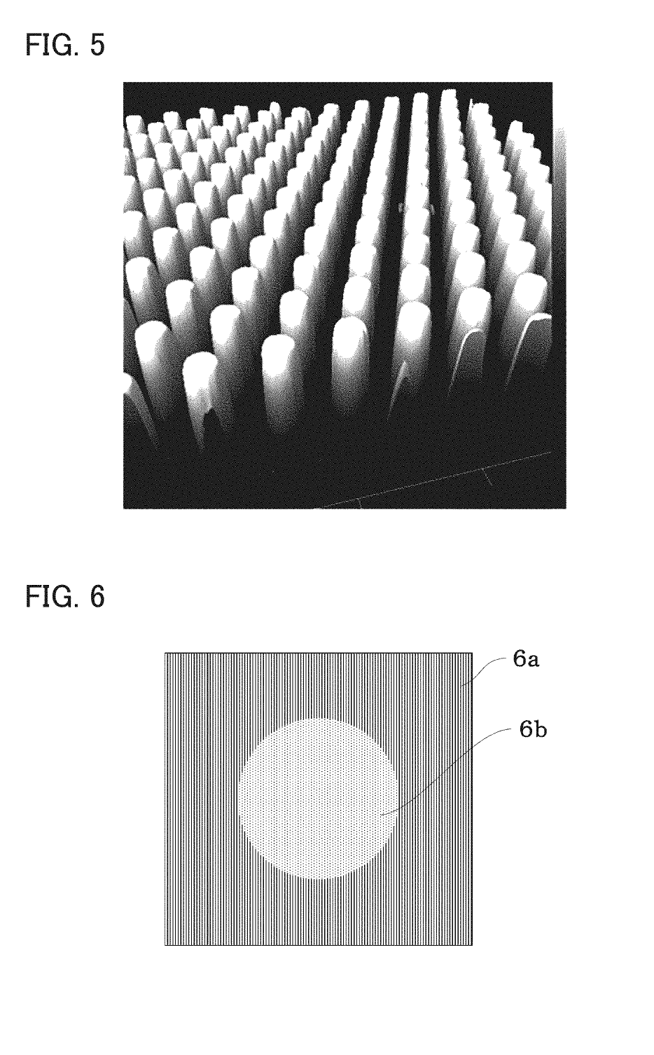

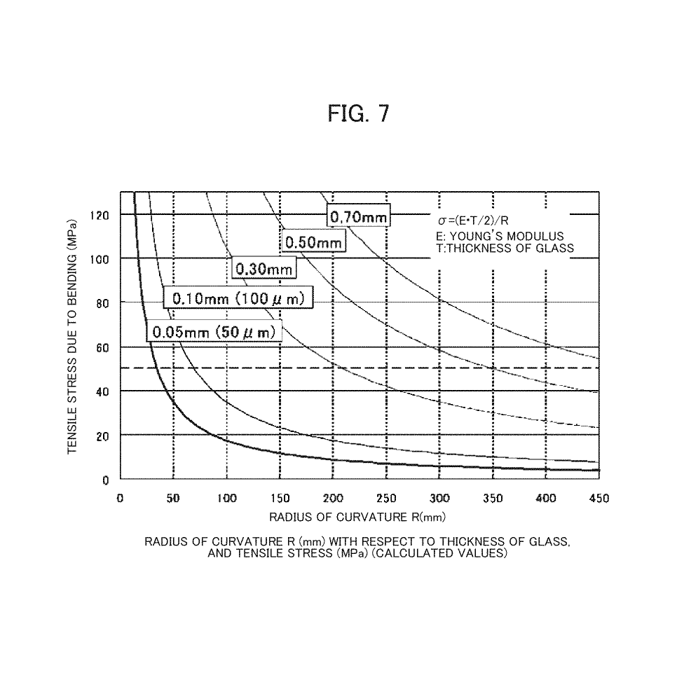

FIG. 4 illustrates the replica template used to form the nanopillar structure.

The concave-convex pattern is formed in the center circular area. The concave-convex pattern had the dimensions shown in Table 1.

TABLE 1

| Area of pattern | Diameter of pillar | Height of pillar | Pillar pitch |
|---|---|---|---|
| 120 mm (diameter) | 230 nm | 200 nm | 460 nm |

An imprint experiment in which the pattern was imprinted on a 4-inch (diameter of 100 mm) sapphire substrate using the replica template was performed.

The imprint experiment was performed using a device “MA6 SCIL” (manufactured by Suss MicroTec).

FIG. 5 illustrates the pattern transferred onto the resist (observed using a scanning probe microscope (SPM)).

It was confirmed that the concave-convex pattern of the replica template was accurately transferred with respect to the shape and the dimensions. FIG. 6 illustrates a method for decorating a substrate that utilizes a nanoimprint template that is produced according to the invention.

The invention is characterized in that the replica template has a structure in which the resin film mold is bonded to the buffer resin layer.

According to this feature, the type of the resin film mold that is bonded to the buffer resin layer can be arbitrarily selected. It is also possible to bond a plurality of different patterns at arbitrary positions by combining a plurality of resin film molds (e.g., screen tone), and implement decoration that utilizes a structural color derived from the nano structure.

For example, it is possible to implement a design (e.g., illustration) by providing the patterns 6a and 6b illustrated in FIG. 6.

According to related-art technology, it is necessary to provide a master mold that has the desired design. According to the invention, however, it is possible to easily produce a replica template having an arbitrary design without requiring a considerable capital investment, by providing several screentones using an existing resin film mold.

It is also possible to easily implement automated nanostructure decoration technology by utilizing CAD or a cutting plotter.

The imprint template according to the invention is mainly useful for UV nanoimprint technology. but may also be appropriately applied to soft lithography (e.g., thermal nanoimprinting and contact printing).

The imprint template according to the invention may be used to produce a large-capacity recording disc, a semiconductor device, a bio device (e.g., biosensor and fluidic device), an optical device, and the like, and may also be used to implement decoration technology.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. An imprint template comprising:
a support plate that is transparent with respect to an exposure wavelength used for photocuring imprinting, and has flexibility;
a buffer resin layer that is formed on the support plate, and is transparent with respect to the exposure wavelength; and
a resin film mold that is removably bonded to the buffer resin layer, and is transparent with respect to the exposure wavelength,
wherein a concave-convex transfer pattern is formed on a surface of the resin film mold.

2. The imprint template as defined in claim 1,
wherein the support plate is formed of transparent glass or a transparent resin, and has a thickness of 0.1 mm or more and less than 0.5 mm.

3. The imprint template as defined in claim 1, further comprising:
a release film that is formed on the surface of the resin film mold at least in an area in which the concave-convex transfer pattern is formed.

4. The imprint template as defined in claim 1,
wherein the resin film mold is formed of a cyclo-olefin polymer resin.

5. A method for producing an imprint template comprising:
forming a buffer resin layer on a surface of a support plate, the support plate being transparent with respect to an exposure wavelength used for photocuring imprinting, and having flexibility, and the buffer resin layer being formed of an elastic material that is transparent with respect to the exposure wavelength; and
subjecting a back surface of a resin film mold that is transparent with respect to the exposure wavelength to a plasma treatment, and bonding the back surface of the resin film mold to a surface of the buffer resin layer, a concave-convex transfer pattern being formed on a front surface of the resin film mold.

6. The method for producing an imprint template as defined in claim 5,
wherein the support plate is formed of transparent glass or a transparent resin, and has a thickness of 0.1 mm or more and less than 0.5 mm.
